(19) United States
(12) Patent Application Publication
(10) Pub. No.: US 2016/0273444 A1
(43) Pub. Date: Sep. 22, 2016

(54) INTERNAL COMBUSTION ENGINE

(71) Applicant: SPEED OF AIR, INC., Reno, NV (US)

(72) Inventor: Joey A. Malfa, Reno, NV (US)

(21) Appl. No.: 15/028,711

(22) PCT Filed: Oct. 9, 2014
(86) PCT No.: PCT/US14/59965

§ 371 Date: Apr. 11, 2016

Related U.S. Application Data
(60) Provisional application No. 61/889,471, filed on Oct. 10, 2013.

(51) Int. Cl. F02B 23/08; F02F 3/28; F02F 1/24

(52) U.S. Cl. CPC F02B 23/08; F02F 1/24; F02F 3/285

(57) ABSTRACT

An internal combustion engine including a cylinder having an inner cylinder wall, a piston having a crown received in the cylinder, and a cylinder head coupled to the cylinder. The cylinder head defines an intake port and an exhaust port. The piston is configured to reciprocate between a top dead center position and a bottom dead center position. Wherein when the piston is in the top dead center position, the inner cylinder wall includes an exposed portion above the crown. A combustion chamber is defined between crown of the piston, the exposed portion of the inner cylinder wall, and an inner surface of the cylinder head. The exposed portion of the inner cylinder wall includes a series of surface features to promote mixing of an air-fuel mixture in the combustion chamber.

### FIELD

The present disclosure is directed generally to internal combustion engines and, more particularly, to internal combustion engines having a cylinder wall with surface features to promote homogenous mixing of the air-fuel mixture in the combustion chamber.

### BACKGROUND

Internal combustion engines are utilized in wide array of applications, including automobiles, agricultural vehicles, and maritime vehicles. In an internal combustion engine, an air-fuel mixture is injected into the combustion chamber and then a piston compresses the air-fuel mixture during a compression stroke. However, in conventional internal combustion engines, the air-fuel mixture may not be completely mixed, creating a non-homogeneous air-fuel mixture. A non-homogeneous air-fuel mixture in the combustion chamber reduces the amount of proper air-fuel mixture available to create power during the combustion cycle, and thereby reduces the efficiency and power output of the engine.

Additionally, the non-homogeneous air-fuel mixture in the combustion chamber may also increase the amount of hydrocarbon emissions from the engine. Accordingly, conventional internal combustion engines commonly include one or more exhaust gas treatment components, such as catalytic converters, air injection, exhaust gas recirculation (EGR), and oxygen sensors to reduce emissions from unburned fuel. However, such solutions are costly.

### SUMMARY

The present disclosure is directed to various embodiments of an internal combustion engine. In one embodiment, the internal combustion engine includes a cylinder having an inner cylinder wall, a piston having a crown received in the cylinder, and a cylinder head coupled to the cylinder. The cylinder head defines an intake port and an exhaust port. The piston is configured to reciprocate between a top dead center position and a bottom dead center position. When the piston is in the top dead center position, the inner cylinder wall includes an exposed portion above the crown. A combustion chamber is defined between the crown of the piston, the exposed portion of the inner cylinder wall, and an inner surface of the cylinder head. The exposed portion of the inner cylinder wall includes a series of surface features to promote mixing of an air-fuel mixture in the combustion chamber.

The exposed portion of the inner cylinder wall may have a height from approximately 1 inch to approximately 1.7 inches. The surface features may be projections, depressions, or combinations thereof. The surface features may have any suitable shape, such as dimples, prismatic shapes, polyhedral shapes, conical shapes, portions of such shapes, or combinations thereof. A series of the surface features may be arranged in contoured matrix-like pattern, a spiral pattern, or a staggered grid pattern. The internal combustion engine may also include a cylinder liner received in the cylinder. The cylinder liner may define the inner cylinder wall and the surface features may be provided on the cylinder liner. The surface features may be integrally formed in the cylinder. The surface features may have an average depth or height from approximately 1/100 inch to approximately 6/100 inch, and an average width from approximately ⅛ inch to approximately 7/20 inch. Edges of adjacent surface features may be spaced apart by an average distance from approximately ⅛ inch to approximately ¼ inch.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a schematic cross-sectional view of a combustion chamber of an internal combustion engine according to one embodiment of the present disclosure; and

FIG. 2 is a schematic cross-sectional view of a combustion chamber of an internal combustion engine according to another embodiment of the present disclosure.

### DETAILED DESCRIPTION

The present disclosure is directed to various embodiments of an internal combustion engine. Embodiments of the internal combustion engine include an inner cylinder wall with a series of surface features configured to promote a homogeneous mixing of an air-fuel mixture in the combustion chamber, thereby improving the efficiency of the internal combustion engine, increase the power output of the engine, and reducing the emission of hydrocarbon pollutants from the engine.

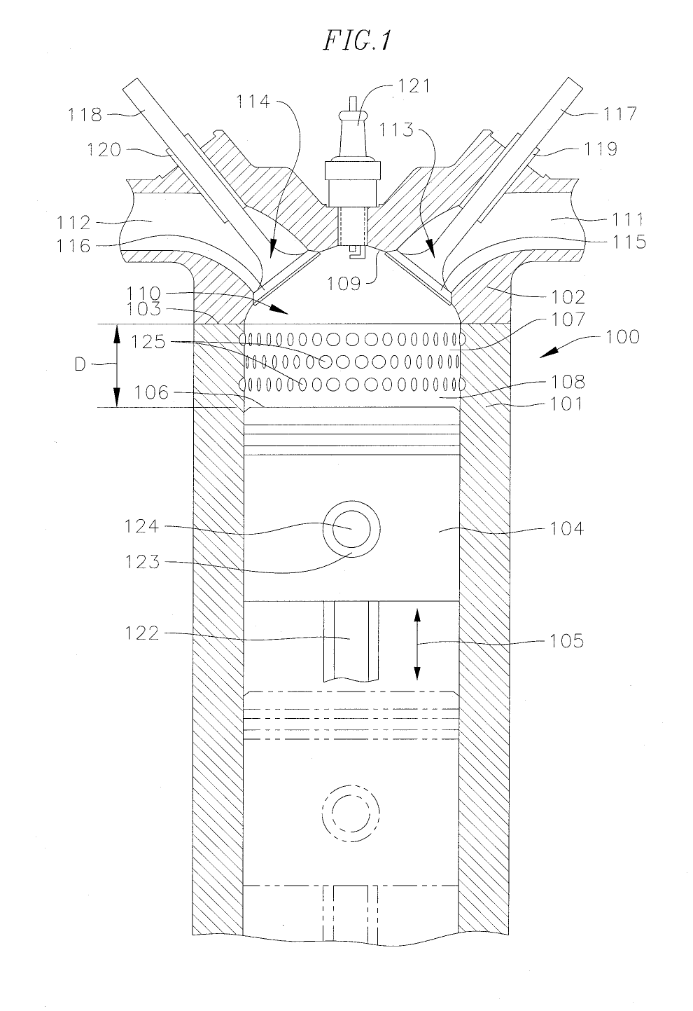

With reference now FIG. 1, an internal combustion engine 100 according to one embodiment of the present disclosure includes a cylinder 101, a cylinder head 102 coupled to an upper end 103 of the cylinder 101, and a piston 104 received in the cylinder 101. The piston 104 is configured to reciprocate (arrow 105) within the cylinder 101 between top dead center position (shown in solid lines) and a bottom dead center position (shown in dashed lines). In the illustrated embodiment, the internal combustion engine 100 is a four-stroke engine. Accordingly, the piston 104 is configured to reciprocate (arrow 105) within the cylinder 101 between an intake stroke, a compression stroke, a combustion stroke, and an exhaust stroke. Although only a single cylinder 101 is illustrated in FIG. 1, the internal combustion engine 100 of the present disclosure may have any suitable number of cylinders, such as, for instance, from one to twenty cylinders.

In the illustrated embodiment, when the piston 104 is in the top dead center position (e.g., the piston 104 is at the end of the compression stroke or the exhaust stroke), an upper surface 106 (i.e., a crown) of the piston 104 is spaced apart by a distance D from the upper end 103 of the cylinder 101. Accordingly, an upper portion 107 of an inner cylinder wall 108 of the cylinder 101 is exposed above the crown 106 of the piston 104 when the piston 104 is in the top dead center position (i.e., the exposed, upper portion 107 of the inner cylinder wall 108 is not covered by the travel of the piston 104 between the top dead center and the bottom dead center positions). Together, the crown 106 of the piston 104, the exposed portion 107 of the inner cylinder wall 108, and an inner surface 109 of the cylinder head 102 define a combustion chamber 110. In one embodiment, the distance D that the crown 106 of the piston 104 is spaced from the upper end 103 of the cylinder 101 is from approximately 1 inch to approximately 1.7 inches. In one or more alternate embodiments, the crown 106 of the piston 104 may be spaced apart from the upper end 103 of the cylinder 101 by any other suitable distance D, depending, for instance, on the desired compression ratio of the internal combustion engine 100. In one embodiment, the distance D is selected such that the internal combustion engine 100 has a compression ratio from approximately 8:1 to approximately 9.7:1.

Still referring to the embodiment illustrated in FIG. 1, the cylinder head 102 defines an intake port 111 and an exhaust port 112. The internal combustion engine 100 also includes an intake valve 113 received in the intake port 111 and an exhaust valve 114 received in the exhaust port 112. The intake valve 113 is configured to direct a mixture of fuel and air through the intake port 111 and into the combustion chamber 110. The exhaust valve 114 is configured to direct exhaust gas from the combustion chamber 110 through the exhaust port 112. The intake valve 113 and the exhaust valve 114 each include a head 115, 116 and a shaft 117, 118 extending from the head 115, 116, respectively. The shafts 117, 118 of the intake valve 113 and the exhaust valve 114 are received within valve guides 119, 120, respectively, coupled to the cylinder head 102. The shafts 117, 118 are configured to slide within the valve guides 119, 120 as the intake valve 113 and the exhaust valve 114 reciprocate between open and closed positions to direct the air-fuel mixture into the combustion chamber 110 and to vent exhaust gas from the combustion chamber 110, respectively. The valves 113, 114 are driven by a cam shaft (not shown) that controls the timing of the opening and closing of each valve 113, 114.

The internal combustion engine 100 also includes an intake manifold for supplying air to the combustion chamber 110 and an exhaust manifold for drawing exhaust gas from the combustion chamber 110. In one or more embodiments, the internal combustion chamber 100 may also include one or more air pressure boosters (e.g., a turbocharger or a supercharger) configured to increase the volume and pressure of the air supplied to the combustion chamber 110. The internal combustion engine 100 also includes a fuel supplier (e.g., one or more fuel injectors or one or more carburetors) for supplying fuel to the combustion chamber 110.

In one or more alternate embodiments, the internal combustion engine 100 may be a two-stroke engine. Accordingly, in one or more embodiments, the internal combustion engine 100 may be provided without the intake valve 113 and the exhaust valve 114. Additionally, although in the illustrated embodiment the cylinder head 102 includes a single intake port 111 and a single exhaust port 112 for the cylinder 101, in one or more alternate embodiments, the cylinder head 102 may define a plurality of exhaust ports and/or a plurality of intake ports for each cylinder 101 of the internal combustion engine 100.

In the illustrated embodiment, the internal combustion engine 100 also includes a spark plug 121 coupled to the cylinder head 102 and extending into the combustion chamber 110. The spark plug 121 provides an ignition source to ignite the air-fuel mixture during the compression stroke of the piston 104. In one or more alternate embodiments, the internal combustion engine 100 may be a compression ignition engine and the internal combustion engine 100 may be provided without the spark plug 121.

With continued reference to the embodiment illustrated in FIG. 1, the internal combustion engine 100 also includes a connecting rod 122. An upper end 123 of the connecting rod 122 is pivotally coupled to the piston 104 by a wrist pin 124, and a lower end of the connecting rod 122 is rotatably coupled to a crank shaft. During the combustion stroke, the piston 104 is forced downward (arrow 105) within the cylinder 101 into the bottom dead center position (shown in dashed lines). As the piston 104 is forced downward within the cylinder 101, the connecting rod 122 coupled to the piston 104 drives the crank shaft, thereby powering the vehicle or other machine into which the internal combustion engine 100 is incorporated.

With continued reference to the embodiment illustrated in FIG. 1, the exposed, upper portion 107 of the inner cylinder wall 108 includes a plurality of surface features 125 configured to promote a homogeneous or generally homogeneous mixture of the air-fuel mixture in the combustion chamber 110. The surface features 125 are configured to disturb the flow of the air-fuel mixture in the combustion chamber 110 and thereby promote mixing of the air-fuel mixture. In one embodiment, the surfaces features 125 are a series of discrete projections and/or discrete depressions. The surface features 125 may have any suitable shape, such as, for instance, hemi- or semi-spherical depressions (e.g., dimples), prismatic shapes, polyhedral shapes, conical shapes, portions of such shapes, or combinations thereof. In one or more alternate embodiments, the surface features 125 may extend continuously or substantially continuously around the inner cylinder wall 108 of the cylinder 101 (e.g., the surface features 125 may extend circumferentially around the inner cylinder wall 108). For instance, in one or more embodiments, the surface features 125 may include a series of continuous or substantially continuous annular projections (e.g., ridges) or annular depressions (e.g., grooves). Additionally, the surface features 125 may have any suitable size. For instance, in one embodiment, the surface features 125 may have an average depth or height from approximately 1/100 inch to approximately 6/100 inch, and an average width from approximately ⅛ inch to approximately 7/20 inch. Additionally, edges of adjacent surface features 125 may be spaced apart from each other by any suitable distance, such as, for instance, by an average distance from approximately ⅛ inch to approximately ¼ inch. Furthermore, in the illustrated embodiment, the surface features 125 are arranged in an offset or staggered grid or matrix-like pattern. In one or more alternate embodiments, the surface features 125 may be arranged in any other suitable pattern, such as, for instance, an aligned grid or matrix-like pattern, a spiral pattern, or a combination thereof.

The surface features 125 are configured to mitigate the tendency for atomized fuel to liquefy inside the combustion chamber 110, thereby creating a non-homogeneous air-fuel mixture in the combustion chamber 110 (e.g., the surface features 125 are configure to mitigate the tendency for the atomized fuel to liquefy on the inner cylinder wall 108). Although not being bound by a particular theory, it is believed that the surface features 125 function as turbulators that induce the formation of a turbulent boundary layer covering the exposed portion 107 of the inner cylinder wall 108 as the air-fuel mixture flows over the surface features 125. Turbulent vortices within the turbulent boundary layer promote mixing of the air and the fuel along the inner cylinder wall 108, and thereby mitigate the formation of liquefied fuel on the inner cylinder wall 108. Without the presence of the surface features 125, laminar flow of the air-fuel mixture over the exposed portion 107 of the inner cylinder wall 108 would tend to permit or encourage the liquefaction of the fuel. Liquefied fuel in the combustion chamber 110 reduces the amount of air-fuel mixture available to create power during the combustion cycle, and thereby reduces the power output of the internal combustion engine 100. Accordingly, by mitigating the liquefaction of fuel in the combustion chamber 110, bum efficiency during the combustion cycle is increased, which increases the power output of the internal combustion engine 100. Incomplete combustion due to the presence of liquefied fuel in combustion chamber 110 also increases the emission of undesirable pollutants from the internal combustion engine 100. Accordingly, mitigating liquefaction of the fuel in the combustion chamber 110 may also reduce hydrocarbon emissions from the internal combustion engine 100. Due to the improved mixing of the air-fuel mixture in the combustion chamber 110 and the concomitant reduction of liquefaction of the fuel by the surface features 125 on the exposed portion 107 of the inner cylinder wall 108, in one or more embodiments, the internal combustion engine 100 may be provided without an exhaust gas treatment component configured to reduce emissions from unburned fuel, such as exhaust gas recirculation (EGR).

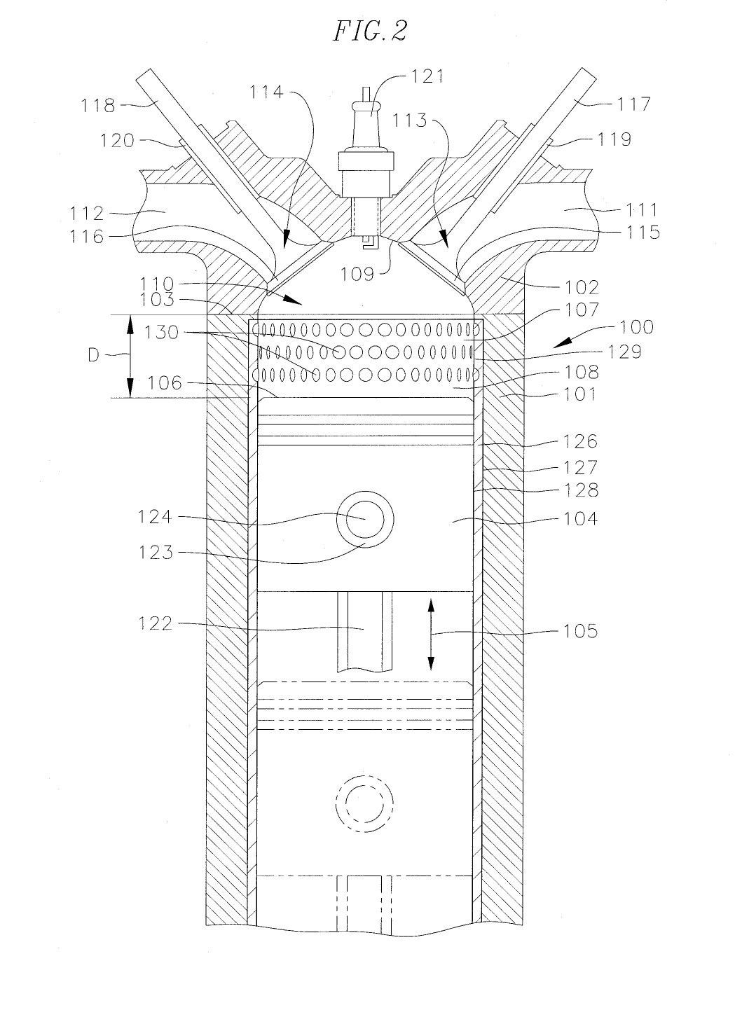

Although in the illustrated embodiment the surface features 125 are integrally or directly formed in the exposed portion 107 of the inner cylinder wall 108, in one or more alternate embodiments, the surface features 125 may be provided on a separate component received in the cylinder 101. For instance, in the embodiment illustrated in FIG. 2, the internal combustion engine 100 includes a liner or a sleeve 126 received in the cylinder 101. The liner 126 includes an outer surface 127 and an inner surface 128 opposite the outer surface 127. The inner surface 128 of the liner 126 defines the inner cylinder wall. Additionally, an exposed, upper portion 129 of the inner surface 128 of the liner 126 includes a plurality of surface features 130 (e.g., projections and/or depressions) configured to promote mixing of the air-fuel mixture in the combustion chamber 110 (i.e., the surface features 130 are provided on the portion 129 of the liner 126 that is exposed above the piston 104 when the piston 104 is in the top dead center position (shown in solid lines)). The surface features 130 may have any suitable, size, shape, and pattern, as described above with reference to the surface features 125 illustrated in FIG. 1.

In one or more embodiments, surface features (e.g., projections and/or depressions) may be provided on any other components or portions thereof of the internal combustion engine 100 to promote a homogeneous mixture of the air-fuel mixture in the combustion chamber 110. Additionally, the surface features may be configured to increase the velocity, pressure, and volume of the air-fuel mixture flowing into the combustion chamber 110. For instance, surface features may be provided on the intake valve 113, the intake port 111, the crown 106 of the piston 104, and/or the inner surface 109 of the cylinder head 102, as described in U.S. Pat. No. 8,813,718, entitled “Internal Combustion Engine,” the entire content of which is incorporated herein by reference.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without , meaningfully departing from the principles, spirit, and scope of this invention. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween.

What is claimed is:

1. An internal combustion engine, comprising:
a cylinder having an inner cylinder wall;
a piston having a crown received in the cylinder, the piston configured to reciprocate between a top dead center position and a bottom dead center position; and
a cylinder head coupled to the cylinder defining an intake port and an exhaust port,
wherein when the piston is in the top dead center position, the inner cylinder wall includes an exposed portion above the crown,
wherein a combustion chamber is defined between the crown of the piston, the exposed portion of the inner cylinder wall, and an inner surface of the cylinder head, and
wherein the exposed portion of the inner cylinder wall includes a plurality of surface features to promote mixing of an air-fuel mixture in the combustion chamber.

2. The internal combustion engine of claim 1, wherein the exposed portion of the inner cylinder wall has a height from approximately 1 inch to approximately 1.7 inches.

3. The internal combustion engine of claim 1, wherein the surface features are selected from the group consisting of projections, depressions, and combinations thereof.

4. The internal combustion engine of claim 1, wherein a plurality of the surface features have a shape selected from the group consisting of dimples, prismatic shapes, polyhedral shapes, conical shapes, portions of such shapes, and combinations thereof.

5. The internal combustion engine of claim 1, wherein a plurality of the surface features is arranged in contoured matrix-like pattern.

6. The internal combustion engine of claim 1, wherein a plurality of the surface features is arranged in a spiral pattern.

7. The internal combustion engine of claim 1, wherein a plurality of the surface features is arranged in a staggered grid pattern.

8. The internal combustion engine of claim 1, further comprising a cylinder liner received in the cylinder, wherein the cylinder liner defines the inner cylinder wall and the plurality of surface features are on the cylinder liner.

9. The internal combustion engine of claim 1, wherein the plurality of surface features are integrally formed in the cylinder.

10. The internal combustion engine of claim 1, wherein a plurality of the surface features have an average depth or height from approximately 1/100 inch to approximately 6/100 inch, and an average width from approximately ⅛ inch to approximately 7/20 inch.

11. The internal combustion engine of claim 1, wherein a plurality of the surface features are spaced apart by an average distance from approximately ⅛ inch to approximately ¼ inch.

12. A cylinder for an internal combustion engine, comprising:
an inner cylinder wall; and
a plurality of surface features on an upper portion of the inner cylinder wall to promote mixing of an air-fuel mixture, the surface features selected from the group consisting of projections, depressions, and combinations thereof.

13. The cylinder of claim 12, wherein the upper portion of the inner cylinder wall has a height from approximately 1 inch to approximately 1.7 inches.

14. The cylinder of claim 12, wherein a plurality of the surface features have a shape selected from the group consisting of dimples, prismatic shapes, polyhedral shapes, conical shapes, portions of such shapes, and combinations thereof.

15. The cylinder of claim 12, wherein a plurality of the surface features is arranged in contoured matrix-like pattern.

16. The cylinder of claim 12, wherein a plurality of the surface features is arranged in a spiral pattern.

17. The cylinder of claim 12, wherein a plurality of the surface features is arranged in a staggered grid pattern.

18. The cylinder of claim 12, further comprising a cylinder liner received in the cylinder, wherein the cylinder liner defines the inner cylinder wall and the plurality of surface features are on the cylinder liner.

19. The cylinder of claim 12, wherein the plurality of surface features are integrally formed in the cylinder.

20. The cylinder of claim 12, wherein a plurality of the surface features have an average depth or height from approximately 1/100 inch to approximately 6/100 inch, and an average width from approximately ⅛ inch to approximately 7/20 inch.

21. The cylinder of claim 12, wherein a plurality of the surface features are spaced apart by an average distance from approximately ⅛ inch to approximately ¼ inch.
